(19) United States
(12) Patent Application Publication
(10) Pub. No.: US 2016/0125152 A1
(43) Pub. Date: May 5, 2016

(54) Multi-Application Integrated Electronic Medical Records & Telemedicine Software Platform

(71) Applicant: Robert Higgs, Evansville, IN (US)

(72) Inventor: Robert Higgs, Evansville, IN (US)

(21) Appl. No.: 14/528,429

(22) Filed: Oct. 30, 2014

(51) Int. Cl. G06F 19/00

(52) U.S. Cl. CPC G06F 19/3418

(57) ABSTRACT

An online system and method for transmitting patient medical records among various server computers and client computers coupled together via a network or cloud system. The online system includes a telemedicine/EHR module configured as a software application accessible to a user terminal that is in communication with a personal health records module for receiving and managing patient records, and a physician's module for receiving selected patient records from the telemedicine/EHR module and the personal health records module. The present invention provides total interoperability of patient medical records information between all present EHR/EMH electronic medical records based systems.

### CROSS REFERENCES TO RELATED APPLICATIONS

U.S. Provisional Application for Patent No. 61/897,407, filed Oct. 30, 2013, with title “Multi-Application Integrated Electronic Medical Records & Telemedicine Software Platform” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

The present disclosure relates to a system and method for capturing, storing, retrieving, and transmitting patient medical records, including longitudinal history and imaging throughout the healthcare system environment, and more particularly, to a system and method for communicating patient medical records that provides optimal medical information service to a subscribed recipient by managing an integrated medical information processing system. The present invention provides total interoperability of patient medical records information between all present EHR/EMR electronic medical records base systems.

2. Brief Description of Prior Art

Comprehensive medical care often requires a patient to visit more than just one doctor. While many patients have established a long-standing relationship with their primary care provider, they are generally unfamiliar with more specialized doctors until medical circumstances necessitate a referral to one. Upon receiving a referral, the patient is usually left to arrange an actual appointment with the specialist. However the patient usually relies upon the patient's primary care provider to timely forward the patient's relevant medical records to the specialist prior to the scheduled appointment. There is little transparency in this process, and under unfavorable circumstances a patient may find himself/herself referred to a doctor who has not been given access to the necessary medical information relating to that patient due to slow delivery, mistaken delivery, and/or failure to deliver. These hurdles may cause delays in medical care, and in some cases even dissuade patients from complying with their primary care provider's recommendation to seek additional medical care from a specialist.

In telemedicine, consultations between patient/physician and remote physician are often being conducted without the benefit of the patient's medical history being available to the consulting remote physician. Additionally, existing EHR/EMR systems do not always communicate with each other whereby patient information can be exchanged.

The problem does not end with the sharing of patient's medical records. There is no protocol for sharing of patient information between the primary and secondary care offices. The process requires someone to establish communications between one or more of the patient's primary care physicians and the secondary care physician(s). The inefficacies in managing this process are a drain on both the primary and secondary physician(s) offices. Often times, the patient, who has the least amount of medical knowledge and often an inability to anticipate or articulate the critical nature or timing of the referral, is left calling one or both offices and communicating with a receptionist who cannot independently determine what the next step in the process should be, without again involving either the primary or secondary care physician(s).

The issues described above have been long-standing problems for both physicians and patients, and substantially interfere with the ability to provide appropriate and cost effective medical care. Every existing electronic medical records based system known to applicant relies upon the health care institution and/or care provider to manage the patient's medical information independently.

The present invention provides total interoperability of patient medical records information between all present EHR/EMR electronic medical records based systems.

### SUMMARY OF THE INVENTION

In one or more embodiments of the present invention, an apparatus and method are provided that allows patients, with the assistance of doctors and theft administrative staff, to manage the process of physician referrals, whereby a patient is referred from one physician (primary care provider) to another physician (the referred-to or receiving physician or specialist) for a particular medical procedure, or analysis or care.

In the preferred embodiment, a system and method is available for sharing of patients medical records throughout the continuum of care involving all care providers, either primary and secondary care providers and/or facilities. The present system allows various means of communications and medical records transfer between multiple health care practitioner practice groups, multiple hospitals and multiple patients. The present system provides for the ability of conducting live interactive video/audio communications through use of an embedded video/audio conferencing module. The system's servers provide a network based service to the patient and all participating care providers, in order to allow the patient's medical records to be made available to selected practitioner groups, hospitals and medical specialists, by providing a web-based data processing service and interface to each of the participating medical providers, and can also communicate electronically via authenticated and encrypted email with each of these medical providers. In the alternative, the services provided to one or more practice groups, one or more hospitals, and/or one or more medical provider(s).

The present system is comprised of three (3) components: the Telemedicine/EHR software client sewer application which serves as the primary health services delivery component of the system. All patient and care provider interaction is driven and recorded by this application, and has the ability of being used in a stand-alone or integrative fashion with the other major components identified; the personal health records web portal provides the patient with ownership of their longitudinal medical history with the ability to transmit the patient's data to an in-network subscribing physician and/or an out-of-network medical provider (the referred-to consulting physician) and the system's third component, the physician's web portal.

The physician's web portal has the ability of being used by any subscribing physician in response to the request by the point of care physician or the patient themselves via encrypted message and email notifications. Upon receipt of a request to provide consultative services by either the point-of-care physician or the patient, the remote physician is required to respond to a set of security questions, and then the physician is directed to their own private web portal. Upon entering the web portal, the physician can select the appropriate patient name, and a window opens that accesses the necessary medical records and a medical encounter worksheet, transmitted by either the patient or the point of care physician, in order for the physician to provide the requested consulting services.

Upon completion of reviewing the medical data and recording their comments, suggestions and recommended orders, the remote physician closes the remote telemedicine window and the results are transmitted back to the point of care physician or to the patient with notification via encrypted message and email. In addition, the system transmits all data submitted by the remote physician to the original source of the request for consult; the Telemedicine/EHR software client server application located at the point of care or to the personal health records web portal of the patient.

These new features bring significant benefits to patients, doctors and hospitals, increasing the efficiency of their work flows and improving patient care while reducing administrative costs, and the probability of errors in patient care. The present system further provides a system and method for eliminating inefficacies in the sharing of patient information, enabling, for example, the referring doctor to track a patient's progress after treatment by a specialist, thereby eliminating uncertainty and allowing more effective treatment. In this regard, the system and method provides a sound system and method for reviewing a patient's progress after a referral appointment, by facilitating direct communications between the referring physician, the referred-to physician and all other care team members across the continuum of care.

### BRIEF DESCRIPTION OF THE DRAWINGS

FIG. 1 is a schematic representation of an exemplary communications network for implementing various embodiments of the present invention.

FIG. 2 is a block diagram of an exemplary communications network for implementing various embodiments of the present invention;

FIG. 3 is a schematic representation of the cloud service for implementing the present invention.

FIG. 4 is a block diagram illustrating an interface structure of the cloud service for implementing the present invention.

### DESCRIPTION OF THE PREFERRED EMBODIMENT

In the preferred embodiment of the present invention, an apparatus and method is provided that manages the medical records data of a patient across the continuum of care involving multiple care providers or medical institutions for the purposes of receiving medical services involving, but not limited to, the process of physician referrals, whereby a patient is referred from one physician (primary care provider) to another physician (the referred-to or receiving physician or specialist) for a particular medical procedure, or analysis or care. Unlike the prior art, the present invention is a multi-application records based platform that uses a Personal Health Records (PHR) as its foundation. The system is built on a patient-centered architecture that travels with the patient and is owned by the patient rather than the health care institution or medical care provider. As will be described, the present software platform as disclosed consists of components configured and correlated with respect to each other so as to attain the desired objective.

Transfer of Patient Records

Over the course of a multi-doctor treatment process, a patient's medical records must often be transferred between several offices. Each of these transfers carries with it the possibility of document loss, and the frequent use of physical (paper) patient records only serves to increase this risk.

There is no widely used specialized procedure in place to efficiently facilitate transfer of records between healthcare providers either in private practices or Hospital-based physicians, meaning that a responsible patient and cooperative, well-organized practices must be present to ensure each doctor is properly informed. Three-way communication between the patient and multiple medical services locations is at best cumbersome, and at worst ineffective in ensuring that records are transferred completely and in a timely fashion. Breakdowns in communication and record transfers can lead to unnecessary procedures, inappropriate medication, preventable deaths, and superfluous testing that combine to create additional cost for patients and insurance providers, all the while eroding trust in medical providers and causing frustration on all sides.

The present invention is directed to a solution that provides for the capture, storage, retrieval and transmission of patients medical records including longitudinal history and imaging throughout the healthcare system environment. The present system resolves problems associated with interoperability between existing and legacy health records systems by providing one central all-inclusive repository of patient data by way of a cloud-based personal health records software solution.

According to the preferred embodiment of the invention described below, a method and apparatus are provided which allows a patient to make his/her necessary medical information available to referred-to physicians and different practice groups. Furthermore, the referring doctor can track a patient's progress after treatment by a specialist, eliminating uncertainty and allowing for more effective treatment at their next meeting. Document loss becomes a non-issue, as digitally archived documents cannot be lost or misplaced.

The present system generally includes three (3) major components:

1. Telemedicine/EHR Software Application.

2. Personal Health Records Web Portal.

3. Physicians Web Portal

The Telemedicine/EHR Software Client Server Application serves as the primary physician-based health services delivery component of the present system used at the point of care. AH point-of-care patient and care provider interaction is driven and recorded by this application. The Telemedicine/EHR Software Application has the ability of being used in a stand-alone or integrated fashion with the other major components as identified in the present system. It provides complete capture, storage, retrieval, recording and transmission capabilities of all patient and physician data.

The Personal Health Records Web Portal serves as the central repository for all patient medical records. The Personal Health Records Web Portal receives, stores, and transmits from, all patient medical data and records.

The Physicians Web Portal is for use in connection with remote medical consultations with the ability to transmit patient data in a store-forward fashion and supported by live video/audio technologies that are embedded within the system and inter-connected with both Telemedicine/EHR Software Server Client Application and the Personal Health Records Web Portal. The Physicians Web Portal has the ability of being used by any subscribing physician in response to the request by the point of care physician or by the patient via encrypted message and email notifications.

The transfer of medical records to the Physicians Web Portal is initiated by either the patient or the care provider. In cases involving the patient, the Personal Health Records Web Portal would be utilized. If from a care provider, the Telemedicine/EHR Client Server Software application would be utilized. In any case, the user (patient or care provider) would select a physician from various internal sources, select what additional medical data in addition to all structured data required by the remote or distant care provider, input a message or instructions as to the purposes of the consultation, and then transmit an encrypted message and email to the remote physician.

Upon receipt of a request to provide consultative services, the remote physician responds (clicks) on a web link as provided in the message/email, and the remote physician is then directed by the system to a secure personal web portal.

The remote physician is then required to respond to security questions such as a username and password. The system then authenticates the user's security.

Upon entering the correct security information, the remote physician is then directed to their own private web portal within the system. Upon entering their web portal, they will see all open consultation requests for services. The remote physician can then electronically select the appropriate patient name and a window opens that accesses all of the patient's longitudinal medical information to include imaging or other related patient data files required for the secondary care physician, including the active medical encounter, if sent from the Telemedicine/EHR Software application, for use in providing the consulting services requested. All medical data is also made available in structured form using the NIST standard for CCR, CCD, CDA or C-CDA for use by the remote physicians in downloading said data into their respective disparate operating system.

Post-Referral Reporting on Doctors

By referring patients to another physician, a doctor effectively grants a colleague access to trust-based doctor-patient relationships that form the core of his/her business. It is accordingly in the referring doctor's interest, both from a professional standpoint and with a view to his or her own reputation, to ensure that patients referred elsewhere receive care quickly and efficiently, and that they are satisfied with their patient experience. Without a tool to systemically track post-referral care, doctors rely on intuition when deciding where to refer their patients. Other than time consuming individual follow-ups to every referral, there is little a doctor can do to gain an overview of and assess the doctor-patient relationships being built between “his” or “her” own patients and the specialist he or she refers to.

Comprehensive reporting on referrals and follow-up is a central feature of the present system. This allows doctors to more objectively evaluate professional relationships, which in turn should create benefits for patients hoping to be referred to reliable and confident doctors. Practices deficient in sharing documents or making use of information shared can be more easily identified.

In the present invention, and, in the scenario involving the Telemedicine/EHR Software application, upon completion of reviewing data and recording their comments, suggestions and recommended orders (medications, tests, ect.) the remote physician closes the remote telemedicine window and the results are transmitted back to the point of care physician with notification to the point of care physician via encrypted message and email. The point of care physician can then open the patient's encounter and either accept or reject the recommendation whereby all data is made a part of the patient's encounter record. At the conclusion of the medical encounter, the point of care system transmits all data to the patient's personal health records web portal.

The present system provides the ability of the medical data received from the remote physician to include imaging from any EMR/EHR in structured format and parse (process) the received medical data by processing the structured data for inclusion in the patient's personal health records web portal. The system further includes a reconciliation process where the data received from the remote physician is logically compared with the data in the personal health records web portal to avoid duplication. In this regard, the reconciliation process is both automatic and manual in that all data received is brought to a user webpage screen and presented to the user with both existing data and newly received data so that the user can either accept or reject the inclusion (into the personal health records portal) of the newly received data at the user's discretion,

Should the patient decide to secure a second opinion or simply visit another care provider, the patient transmits or downloads any and all of their medical records including imaging to the next care provider with the ability of collecting all data from the provider for a return to theft ail-inclusive personal health records based system.

As should be understood, all three major components of the present system are relationship database driven. The logic gateways have been developed to provide automated notifications to respective parties (patients and medical care providers) based on thousands of user actions representing data received with corresponding actions to be taken regarding medications, laboratory, immunizations, procedures, radiology, problems, treatments and other instructions.

It is critical to note that the use of the personal health records based system is independent of the medical care provider's own electronic medical records system but yet, capable of communicating with that system or any other medical records based system. This is the founding principle of the present system that cannot be altered.

The telemedicine/EHR software application is used at a point of care setting to assist in providing medical services to the patient and to capture/record all such activities including communications with the physician's web portal in connection with remote telemedicine consultations and personal health records web portal to serve as a virtual life-time patient medical records based system. The personal health records web portal serving as the central repository for all patient medical records across the complete spectrum of the global health care environment. As such, this solution provides the ability to capture, receive, parse, store and transmit any/all data to and from the telemedicine/EHR software application and the physician's web portal in an integrated fashion. Similarly, the physician's web portal provides the ability to accept, access patient data from the telemedicine/EHR software application and the personal health records web portal for the expressed benefit of providing consultation services and to record all such services and transmit said data back to either the telemedicine/EHR software application or the personal health records web portal, or both.

The present disclosure relates to a system and method for processing medical information, and more particularly, to a system that provides optimal medical information service to the patient and the care provider by managing and integrative medical information processing system independently operated using a cloud system.

Domestic medical information processing technology includes Picture Archiving Communication System (PACS), Order Communication System (OCS), and Electronic Medical Record (EMR), which comply with Health Level 7 (HL7). Medical information processing is independently managed by individual hospitals. Particularly, EMR has been developed into the Electronic Health Record (EHR) concept that is a lifetime electronic health record of individual patients.

However, EHR independently operated need to be integrated according to standardization for high quality medical service of individuals. For this, integrated system technology is needed, and for example, a cloud computing model is being applied.

Cloud computing is a next generation computing technology in which Software as a Service (SaaS) for web 2.0 service and utility computing are complexly combined.

The service structure of cloud computing may include a server for using IT environment, storage, Infrastructure as a Service (IaaS), Platform as a Service for providing a basis for development of software, Software as a Service (SaaS) in which a computing provider supplies and uses software through Internet. The present system may further include mobile browser technology which is a software-manufacturing technology with an app structure used to independently provide developed services to a user in a smart environment.

Network Communications

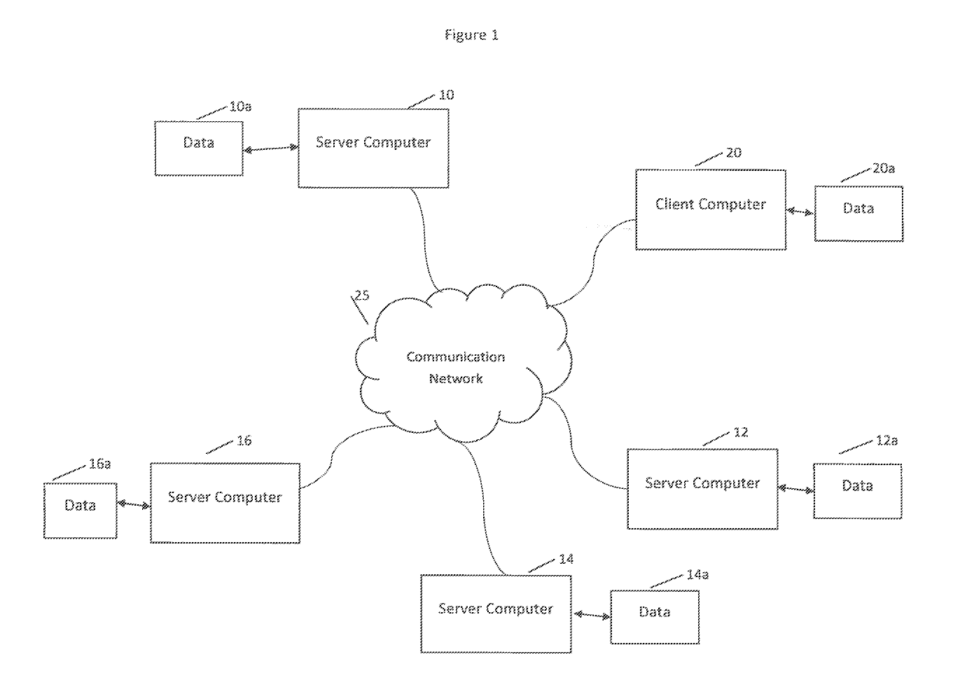

Apparatus and methods are described herein for improving the referral process between a patient's primary care provider and the referred-to specialized physician, for example. The present system serves as the primary health services delivery component. For these purposes, network based communications are required between patients, and the subscribing physicians and physician practice groups. The block diagrams of one such communication system is illustrated in FIG. 1 and is meant to be representative only. Suitable hardware, communication protocols and software languages for implementing the systems and methods of various embodiments of the invention are readily known to those who are skilled in the art and any discussion herein is not to limit the scope of the invention.

FIG. 1 illustrates schematically network communication among various server computers 10, 12, 14, 16 and client computers 20 shown coupled together via a network or cloud 25 (eg., the Internet) to communicate with one another using standard communication protocols. The servers can be any type of server, including but not limited to a Windows, Unix, Linux and/or Apple servers. Each server and client computer may have an attached data storage system 10a, 12a, 14a, 16a, and 20a, respectively, for storing software applications and data.

In accordance with the preferred embodiment of the present invention, the network of FIG. 1 allows communications between multiple patients, and multiple health care practitioners and health care practitioner groups, and multiple hospitals. The server(s) provides a network based service to the patients, practitioners, practitioner groups, and hospitals, and provides a web-based data processing service and interface to each of the subscribers, and can also communicate electronically via email with each of these computers and servers. The server also communicates (e.g. web-based) with each of the practice groups, hospitals via their respective servers both retrieving medical data for the respective patient's personal health records web portal, as discussed.

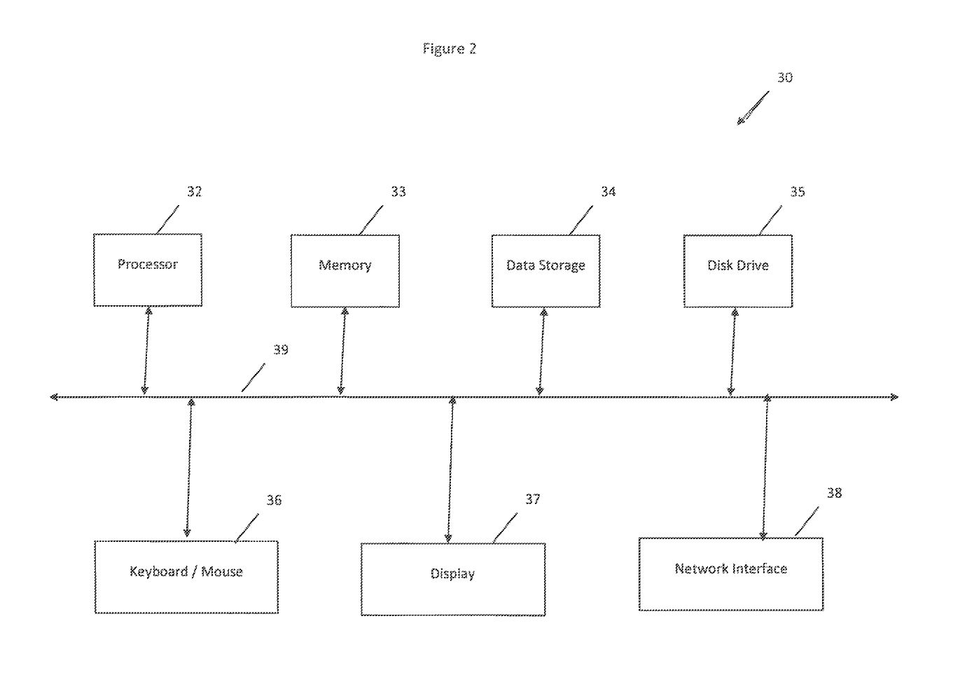

FIG. 2 is a block diagram of one server 30 which includes a processor 32, memory 33, data storage 34, disk drive 35, keyboard/mouse 36, computer display 37 and network interface 38. The components are coupled together and communicate via a system bus 39. Various software modules of the present invention can be loaded into data storage and during operation are transferred in to memory (e.g. RAM) for execution by the processor. A user (e.g. patient) may manipulate the software and enter commands to server using the keyboard/mouse. The input/output may be viewed on the display screen. The network interface couples the server to Internet or whatever type of network is used to connect the server with the other computers and servers of the respective patients, physicians, practice groups, and hospitals. Further, the server may communicate with a storage array or storage network (e.g. SAN) if there is a need to access large amounts of data. The database of patient records may be implemented as a relational database with a selected search engine from any number of search engine providers.

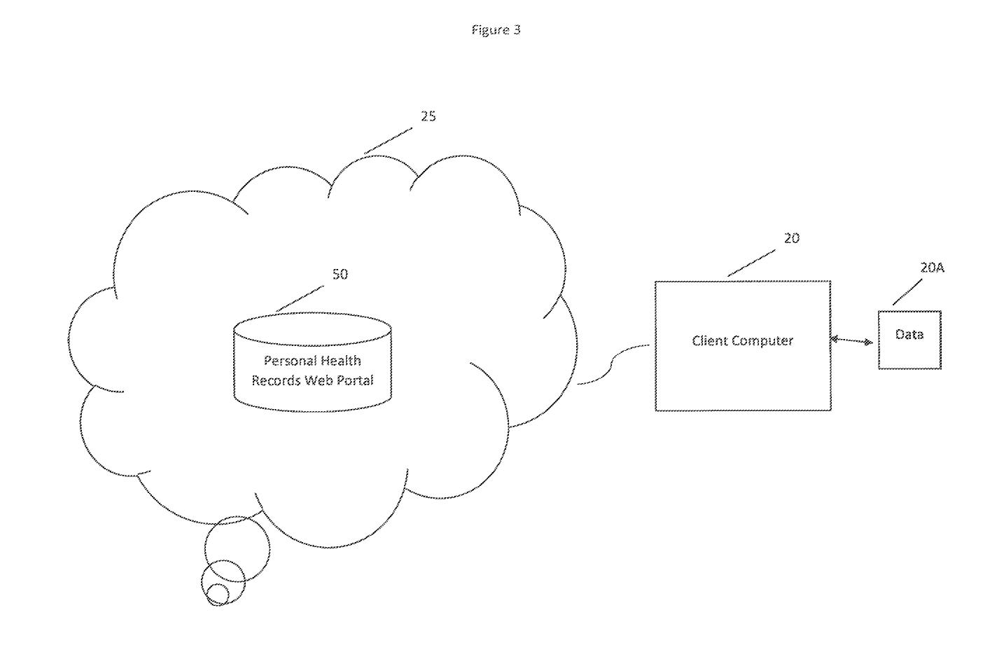

As shown in FIG. 3, in the present invention, the cloud technology 25 includes the Personal Health Records Web Portal data 50 and the Physicians Web Portal data 60 in communications with the Telemedicine/EHR Software Application 1. The software application 1 in bi-directional communication with the client computers 20 (patients, physicians, ect).

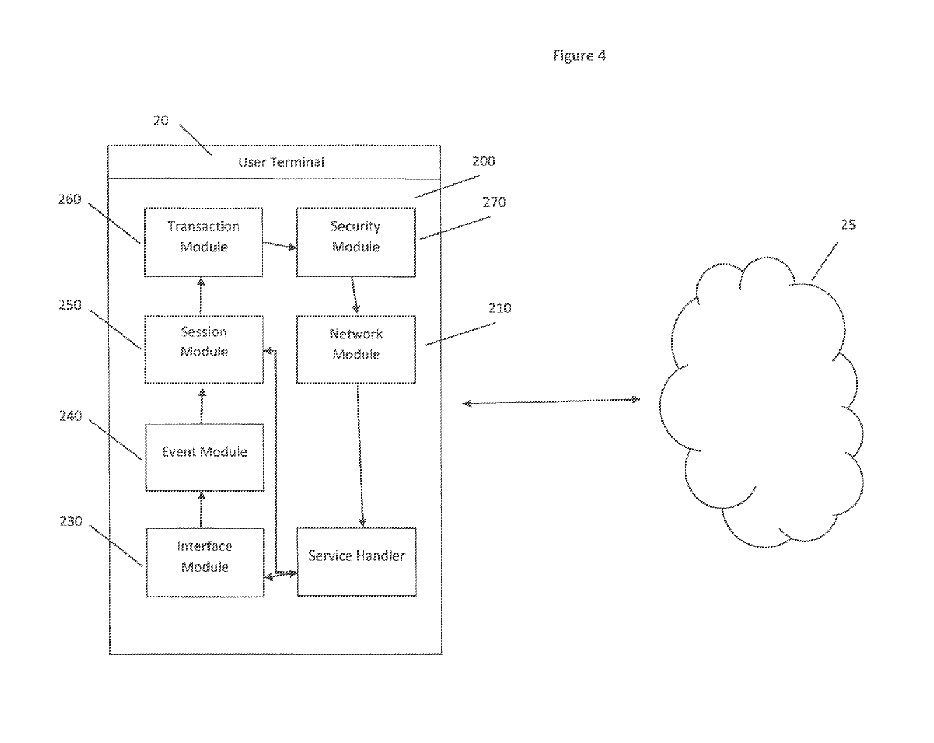

As shown in FIG. 4, in a medical information processing system, a medical information processing cloud system 25 in which information processing services are integrated may be assessed using information processing tools such as smart phone terminals and personal computers. In the present invention, a patient is endowed with access authority and use medical information services in real-time according to his/her demand.

The medical information processing system includes a service browser 200 that is included in a terminal of a user in a form of application to allow the user to use a medical information processing service and induce access to the cloud service 25 taking charge of medical information processing.

Specifically, the service browser unit 200 may include a user interface module 230 providing a service application of an icon type to the user through access identification, and event module 240 generating event information, a session module 250 managing a network environment of the user and maintaining a connection situation according to a change of the network environment, a conversion module 260 encoding and converting the information into a compression code according to a predetermined protocol, a security module 270 encoding the user information configured by the conversion module to securely configure virtualization of the cloud server together with user access information, a network module 210 delivering the user information to the cloud system 25 and monitoring a network state, and a service handler 220 configuring a user interface with the information received from the cloud system 25.

The service browser unit 200 in communication with the Telemedicine/EHR Software Application 1. Accordingly, a user (physician/care provider) connected to the Telemedicine/EHR Software Application may configure to the software application 1 to transmit to the cloud system 25 in real-time, and may submit the user situation information generated in the interface module 230 and the event information generated in the event module to the Personal Health Records Web Portal 50 and/or Physician's Web Portal 60 in the cloud system unit 25. The cloud system 25 providing services to a user may include a typical structure that provides a cloud service.

The present system as disclosed can operate in both local and local remote mode. In this regard, the system continually or systematically “pings” or tests whether the user terminal is reachable or connected with the cloud system 25. When there is a connection, patient data for that user stored on the personal health records web portal 50 can be stored (and replaced) on the data storage 34 of the user's terminal using SQL Express Service or other like local storage database. As a result, when the user terminal is not able to connect with the cloud system, the patient's user terminal will have available the patient's up-to-date medical records as contained in the Personal Health Records Web Portal.

As used herein, database is meant to include any of various types of data repositories and processes for indexing, searching, storage and retrieval from such repositories.

An e-mail module allows encrypted e-mails with authentication to be sent to/from patients, physicians, practice groups, hospitals, via the respective server/computer. The e-mails can be sent manually by a person operating the server and can be automatically generated by the server. For example, the e-mail module can be configured to automatically query the database module and send e-mail messages to entities identified in the database module.

The software may include standard APIs so data and other information can be exchanged with other software systems. The system can further include a DICOM viewer module for viewing and processing “native” DICOM imaging from any known source, for both the Personal Health Records Portal and the Physicians Portal.

Physicians and Practice Groups

In various embodiments of the present invention disclosed herein, the term “physicians”, “care providers” or “doctor” refers to a physician administering patient care, as well as to those members of his/her staff responsible for maintaining the physician's patient records. Though the term is used interchangeably, it should be understood that in the exemplary figures and texts, each function is being performed by one or more persons that perform such activities in a particular doctor's office on behalf of a licensed physician.

The term “specialist” is applied to a physician administering secondary care to a patient after a referral from a referring physician, and is also applied to other members of his/her staff in the same manner as is done for the physician. It may be possible for any given physician to in one situation be a specialist (receiving a patient via referral), and in another be a primary care physician (referring a patient to another physician for specialized care).

Further a “provider group” “practice group ” may be any entity linking a group of doctors through shared facilities, services, or referral agreements. This can include but should not be limited to integrated multi-facility hospitals, medical groups, and multi-doctor practices.

System, Method and Computer Program

As will be appreciated by one skilled in the art, the present invention may be embodied as an apparatus or method, including a computer system or computer program product. Accordingly, unless specified to the contrary, the present invention may take the form of an entirely hardware embodiment, and entirely software embodiment (including firmware, resident software, micro-code, ect.) or an embodiment combining software and hardware aspects that may all generally be referred to herein as a “circuit,” “module” or “system.” Furthermore, the present invention may take the form of a computer program product embodied in any tangible medium of expression having computer-usable program code stored in the medium.

Any combination of one or more computer-usable or computer-readable medium(s) may be utilized, unless specified to the contrary herein. The computer-usable or computer-readable medium may be, for example, but not limited to, electronic, magnetic, optical, electromagnetic, infrared, or semiconductor storage mediums. More specific examples (a non-exhaustive list) include: a portable computer diskette, a hard disc, a random access memory (RAM), a read-only memory (ROM), an erasable programmable read-only memory (EPROM or Flash Memory), and a portable compact disc read-only memory (CDROM), an optical storage device.

Further, the present invention is described above with reference to flowchart illustrations and/or block diagrams of methods, apparatus and computer program products (systems) according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprise one or more executable instructions for implementing the specified logical function(s). It should also be noted that, in some alternative implementations, the functions noted in the block may occur out of the order noted in the figures. For example, two blocks shown in succession may in fact, be executed substantially concurrently, or the blocks may sometimes be executed in the reverse order, depending upon the functionality involved. It will also be noted that each block of the block diagrams and/or flowchart illustration, and combinations of blocks in a block diagrams and/or flowchart illustration, can be implemented by special purpose hardware-based systems that perform the specified functions or acts, or combinations of special purpose hardware and computer instructions.

Although the above description contains many specificities, these should not be construed as limiting the scope of the invention but as merely providing illustrations of some of the presently preferred embodiments of this invention. As such, it is to be understood that the present invention is not limited to the embodiments described above, but encompasses any and all embodiments within the scope of the claims.

I claim:

1. An online system for transmitting patient medical records, comprising:
a cloud system,
a telemedicine/EHR module configured as a software application accessible to a user terminal to allow a user to use a medical information processing service, and inducing access to the cloud system taking charge of medical information processing,
a personal health records module, and
a physician's module,
wherein said personal health records module for receiving and managing patient records and transmitting selected patient records to said telemedicine/EHR module and said physician's module, and
wherein said physician's module for receiving selected patient records from said telemedicine/EHR module and said personal health records module and transmitting selected data to said telemedicine/EHR module and said personal health records module,
said telemedicine/EHR module further including a user interface enabling the user to select patient records on said personal health records module and transmit said selected patient records to said physician's module,
said telemedicine/EHR module further including a security module such that a referred-to physician is unable to access said transmitted selected patient records without a unique identifier.

2. The online system as recited in claim 1, wherein the user is connected to the telemedicine/EHR module to transmit to the cloud system in real-time,

3. The online system as recited in claim 2, wherein the telemedicine/EHR module comprises an interface function of accessing from said user terminal to said cloud system and a function of outputting, managing, and software processing an event generated by the personal health records module and the physician's module and expressed as an icon usable by the user.

4. The online system as recited in claim 3, further including a platform connection module that provides a function of connecting between platforms for managing the cloud system for medical information processing and information resourced and allows a user terminal comprising a function of virtualizing resources necessary for service processing to access the cloud system.

5. The system as recited in claim 4 wherein the telemedicine/EHR module provides a function of checking the physician's identifier, securing an authority to use and access said selected patient records on said physicians module.

6. The system as recited in claim 5, wherein said user terminal operates in both local and local remote mode.

7. The system as recited in claim 6, wherein said system timely pings for internet connectivity with said cloud system.

8. The system as recited in claim 7, wherein when said user terminal has said internet connectivity, said patient data for that user can be transmitted from said personal health records module and locally stored on said user terminal.

9. The online system as recited in claim 1, wherein the telemedicine/EHR module enables the user to conduct interactive video conferencing with the referred-to physician using an embedded video module.

10. The online system as recited in claim 5, wherein said telemedicine/EHR module further enabling the referred-to physician to form a response and transmit a data file including said response and said selected patient records to the user.

11. The online system as recited in claim 10, further including reconciliation means to compare said data file with the data on the personal health records module.

12. The online system as recited in claim 11, further including means to merge the data file with the personal health records module.
